(19) United States
(12) Patent Application Publication
(10) Pub. No.: US 2019/0260694 A1
(43) Pub. Date: Aug. 22, 2019

(54) SYSTEM AND METHOD FOR CHAT COMMUNITY QUESTION ANSWERING

(71) Applicant: MZ IP Holdings, LLC, Palo Alto, CA (US)

(72) Inventors: Nikhil Londhe, San Francisco, CA (US); Shivasankari Kannan, Santa Clara, CA (US); Nikhil Bojja, Mountain View, CA (US)

(21) Appl. No.: 16/272,142

(22) Filed: Feb. 11, 2019

Related U.S. Application Data
(60) Provisional application No. 62/631,546, filed on Feb. 16, 2018.

(51) Int. Cl. H04L 12/58; G06N 5/04; G06N 20/00

(52) U.S. Cl. CPC H04L 51/02; H04L 51/16; A63F 13/85; G06N 5/04; G06N 20/00; H04L 51/04

(57) ABSTRACT

A method, a system, and an article are provided for automatically posting answers to questions generated by users of a chat room. In one example, a set of chat messages is used to develop a database of question and answer pairs. When a subsequent chat message is identified as being similar or identical to a question in the database, the corresponding answer to the question can be retrieved from the database and posted in the chat room.

### CROSS-REFERENCE TO RELATED APPLICATIONS

This application claims the benefit of U.S. Provisional Patent Application No. 62/631,546, filed Feb. 16, 2018, the entire contents of which are incorporated by reference herein.

### BACKGROUND

The present disclosure relates generally to online chat rooms and, in certain examples, to systems and methods for building a database of question and answer pairs and using the database to answer questions received from users of an online chat room.

In general, an online chat room (also referred to herein as a chat community or an online chat messaging system) is a virtual channel or forum in which users can communicate with one another over the Internet, primarily with plain text. Some chat rooms can be provided for specific subjects of interest to the users. For example, a chat room can be associated with a software application and can allow users of the chat room to discuss the software application with other users and/or providers of the software application. In the context of a software application for a multiplayer online game, for example, a chat room can allow users of the online game to interact with one another and exchange ideas, strategies, and/or questions associated with the online game.

### SUMMARY

In general, the subject matter of this disclosure relates to systems and methods for automatic question answering in a chat community, such as a chat room or chat messaging system. Chat messages are retrieved from a chat room and used to develop a database of question and answer pairs. When a subsequent chat message is identified as being similar or identical to a question in the database, the corresponding answer to the question can be retrieved from the database and posted in the chat room. In this way, users of the chat room can post questions and the systems and methods can automatically post responses to the questions.

Advantageously, the systems and methods described herein are able to perform automatic question answering for chat messages, which are generally shorter and less formal than other forms of text communication. Chat messages, for example, typically include abbreviations, spelling errors, little or no punctuation, slang, and/or other informalities. Some of the primary challenges associated with processing chat room data can include, for example, (i) large data volumes containing mostly noisy data, (ii) short message or document lengths that make it difficult to capture enough context information, and/or (iii) rampant usage of Internet language (e.g., informal text or chat speak) making it difficult to process such text. The systems and methods described herein achieve significant improvements in precision, accuracy, and efficiency associated with automatic question answering for chat rooms and other chat communities.

In one aspect, the subject matter described in this specification relates to a method (e.g., a computer-implemented method). The method includes: receiving a stream or sequence of text messages for a chat messaging system, the stream of text messages including messages from a plurality of users of the chat messaging system; processing each text message to generate a plurality of features for the text message; providing the plurality of features for each text message to a question classifier trained to determine, based on the plurality of features, if the text message is or includes a question; identifying, using the question classifier, one or more questions in the text messages; for each identified question, identifying in the stream of text messages a corresponding answer to the question; storing, in a database, each identified question and corresponding answer; determining that a subsequent text message in the stream of text messages includes a question from the one or more questions; retrieving, from the database, the corresponding answer to the question in the subsequent text message; and posting the retrieved answer to the stream of messages for the chat messaging system.

In certain examples, the plurality of features for each text message can be or include a bag of words. Identifying the one or more questions can include determining that each question in the one or more questions relates to a software application used by the plurality of users. Identifying the one or more questions in the text messages can include clustering the one or more questions into one or more groups, with each group including identical questions or similar questions. Identifying the one or more questions in the text messages can include identifying frequently asked questions among the identified one or more questions. Identifying the corresponding answer can include finding a message in the stream of text messages that is semantically similar to the question. Identifying the corresponding answer can include: generating a pool of candidate answers that are semantically similar to the question; and selecting a best answer from the pool of candidate answers.

In various implementations, storing each identified question and corresponding answer can include storing the identified question and corresponding answer in the database as a question and answer pair. Determining that the subsequent text message includes the question can include: processing the subsequent text message to generate a plurality of features for the subsequent text message; using the question classifier to determine, based on the plurality of features for the subsequent text message, that the subsequent text message includes a question; and determining, based on the plurality of features, that the question in the subsequent text message is similar or identical to the question from the one or more questions. The method can include: obtaining a set of training messages for the question classifier, a portion of the training messages including questions; processing each training message to generate a plurality of features for the training message; and training the question classifier to recognize the questions in the training messages based on the plurality of features for the training messages.

In another aspect, the subject matter described in this specification relates to a system having one or more computer processors programmed to perform operations including: receiving a stream or sequence of text messages for a chat messaging system, the stream of text messages including messages from a plurality of users of the chat messaging system; processing each text message to generate a plurality of features for the text message; providing the plurality of features for each text message to a question classifier trained to determine, based on the plurality of features, if the text message is or includes a question; identifying, using the question classifier, one or more questions in the text messages; for each identified question, identifying in the stream of text messages a corresponding answer to the question; storing, in a database, each identified question and corresponding answer; determining that a subsequent text message in the stream of text messages includes a question from the one or more questions; retrieving, from the database, the corresponding answer to the question in the subsequent text message; and posting the retrieved answer to the stream of messages for the chat messaging system.

In various examples, the plurality of features for each text message can be or include a bag of words. Identifying the one or more questions can include determining that each question in the one or more questions relates to a software application used by the plurality of users. Identifying the one or more questions in the text messages can include clustering the one or more questions into one or more groups, with each group including identical questions or similar questions. Identifying the one or more questions in the text messages can include identifying frequently asked questions among the identified one or more questions. Identifying the corresponding answer can include finding a message in the stream of text messages that is semantically similar to the question. Identifying the corresponding answer can include: generating a pool of candidate answers that are semantically similar to the question; and selecting a best answer from the pool of candidate answers.

In some implementations, storing each identified question and corresponding answer can include storing the identified question and corresponding answer in the database as a question and answer pair. Determining that the subsequent text message includes the question can include: processing the subsequent text message to generate a plurality of features for the subsequent text message; using the question classifier to determine, based on the plurality of features for the subsequent text message, that the subsequent text message includes a question; and determining, based on the plurality of features, that the question in the subsequent text message is similar or identical to the question from the one or more questions. The operations can include: obtaining a set of training messages for the question classifier, a portion of the training messages including questions; processing each training message to generate a plurality of features for the training message; and training the question classifier to recognize the questions in the training messages based on the plurality of features for the training messages.

In another aspect, the subject matter described in this specification relates to an article. The article includes a non-transitory computer-readable medium having instructions stored thereon that, when executed by one or more computer processors, cause the computer processors to perform operations including: receiving a stream or sequence of text messages for a chat messaging system, the stream of text messages including messages from a plurality of users of the chat messaging system; processing each text message to generate a plurality of features for the text message; providing the plurality of features for each text message to a question classifier trained to determine, based on the plurality of features, if the text message is or includes a question; identifying, using the question classifier, one or more questions in the text messages; for each identified question, identifying in the stream of text messages a corresponding answer to the question; storing, in a database, each identified question and corresponding answer; determining that a subsequent text message in the stream of text messages includes a question from the one or more questions; retrieving, from the database, the corresponding answer to the question in the subsequent text message; and posting the retrieved answer to the stream of messages for the chat messaging system.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

### DESCRIPTION OF THE DRAWINGS

FIG. 1 is a schematic diagram of an example system for automatic chat room question answering.

FIG. 2 is a schematic data flow diagram of an example system for automatic chat room question answering.

FIG. 3 is a schematic diagram of an example clustering module for generating groups of questions and identifying trends in frequently asked questions.

FIG. 4 is a bar graph of example test results for an automatic chat room question answering system.

FIG. 5 is a plot of precision vs. recall for example test results for an automatic chat room question answering system.

FIG. 6 is a bar graph of example test results for an automatic chat room question answering system.

FIG. 7 is a bar graph of example test results for an automatic chat room question answering system.

FIG. 8 is a flowchart of an example method of answering questions in an online chat messaging system.

### DETAILED DESCRIPTION

In a chat room for an online game (e.g., a massively multiplayer online game), user text messages and other chat data (e.g., emoji or emoticons) can provide a veritable mine of information for game providers on gameplay related issues or features, such as frequently asked questions. The systems and methods described herein can be used to extract this chat data in the form of, for example, question and answer pairs. The extracted chat data can be utilized for a variety of purposes, such as, for example, building chatbots, wikification (e.g., creating a wiki), aiding customer support, improving user engagement, understanding user interests and concerns, and measuring or evaluating the success of new game features. While much of the discussion herein relates to chat rooms for online games, it is understood that the systems and methods are applicable to chat rooms associated with other software applications or subject matter, such as, for example, social media, customer service, online shopping, etc.

Automatically extracting and analyzing chat data for an online game or other domain can be challenging for several reasons. For example, non-threaded, informal messages can make it difficult to not only identify questions among the messages, but also to determine whether a given statement from a conversation bears any relevance to the given question or not. Short sentence lengths and chat speak (e.g., informal language, use of abbreviations, etc.) can introduce errors and make it difficult to determine a context for a question and an answer. Semantic equivalence can be hard to establish given the short sentence length and domain specific subtleties. Further, users often create new terms that can be challenging to recognize and process.

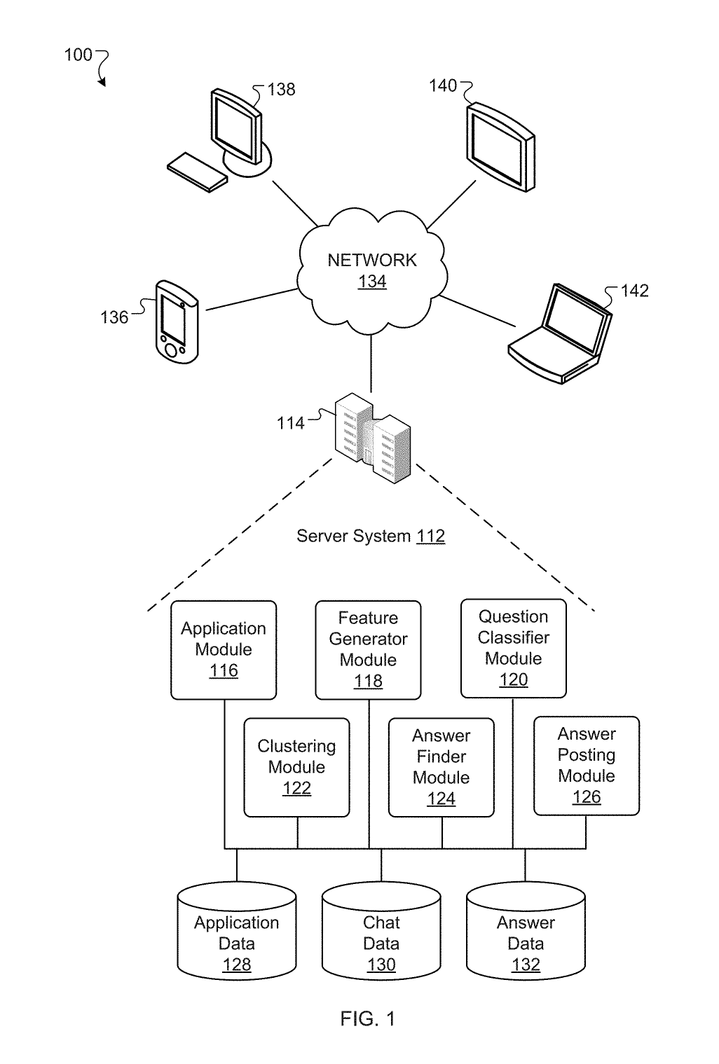

FIG. 1 illustrates an example system 100 for automatically responding to questions from users of an online chat room or chat messaging system. A server system 112 provides functionality for developing a database of question and answer pairs and for using the database to provide responses to questions received from users. The server system 112 includes software components and databases that can be deployed at one or more data centers 114 in one or more geographic locations, for example. In certain instances, the server system 112 is, includes, or utilizes a content delivery network (CDN). The server system 112 software components can include an application module 116, a feature generator module 118, a question classifier module 120, a clustering module 122, an answer finder module 124, and an answer posting module 126. The software components can include subcomponents that can execute on the same or on different individual data processing apparatus. The server system 112 databases can include an application data 128 database, a chat data 130 database, and an answer data 132 database. The databases can reside in one or more physical storage systems. The software components and data will be further described below.

A software application, such as, for example, a client-based and/or web-based software application, can be provided as an end-user application to allow users to interact with the server system 112. The software application can relate to and/or provide a wide variety of functions and information, including, for example, entertainment (e.g., a game, music, videos, etc.), business (e.g., word processing, accounting, spreadsheets, etc.), news, weather, finance, sports, etc. In preferred implementations, the software application provides a computer game, such as a multiplayer online game. The software application or components thereof can be accessed through a network 134 (e.g., the Internet) by users of client devices, such as a smart phone 136, a personal computer 138, a tablet computer 140, and a laptop computer 142. Other client devices are possible. In alternative examples, the application data 128 database, the chat data 130 database, the answer data 132 database or any portions thereof can be stored on one or more client devices. Additionally or alternatively, software components for the system 100 (e.g., the application module 116, the feature generator module 118, the question classifier module 120, the clustering module 122, the answer finder module 124, and/or the answer posting module 126) or any portions thereof can reside on or be used to perform operations on one or more client devices.

FIG. 1 depicts the application module 116, the feature generator module 118, the question classifier module 120, the clustering module 122, the answer finder module 124, and the answer posting module 126 as being able to communicate with the application data 128 database, the chat data 130 database, and the answer data 132 database. The application data 128 database generally includes data used to implement the software application on the system 100. Such data can include, for example, image data, video data, audio data, application parameters, initialization data, and/or any other data used to run the software application. The chat data 130 database generally includes data related to a chat room provided to users of the software application. Such data can include, for example, a history of chat messages generated by users of the chat room, user characteristics (e.g., language preference, geographical location, gender, age, and/or other demographic information), and/or client device characteristics (e.g., device model, device type, platform, and/or operating system). The history of chat messages can include, for example, text messages from users, message timestamps, user statements, and/or user questions. The answer data 132 database generally includes information related to question and answer pairs determined by the system 100. Information in the answer data 132 database can be used by the system 100 to provide responses to questions received from users of the chat room. In various examples, information in the databases can be tagged and/or indexed to facilitate data retrieval, for example, using ELASTIC SEARCH or other search engines.

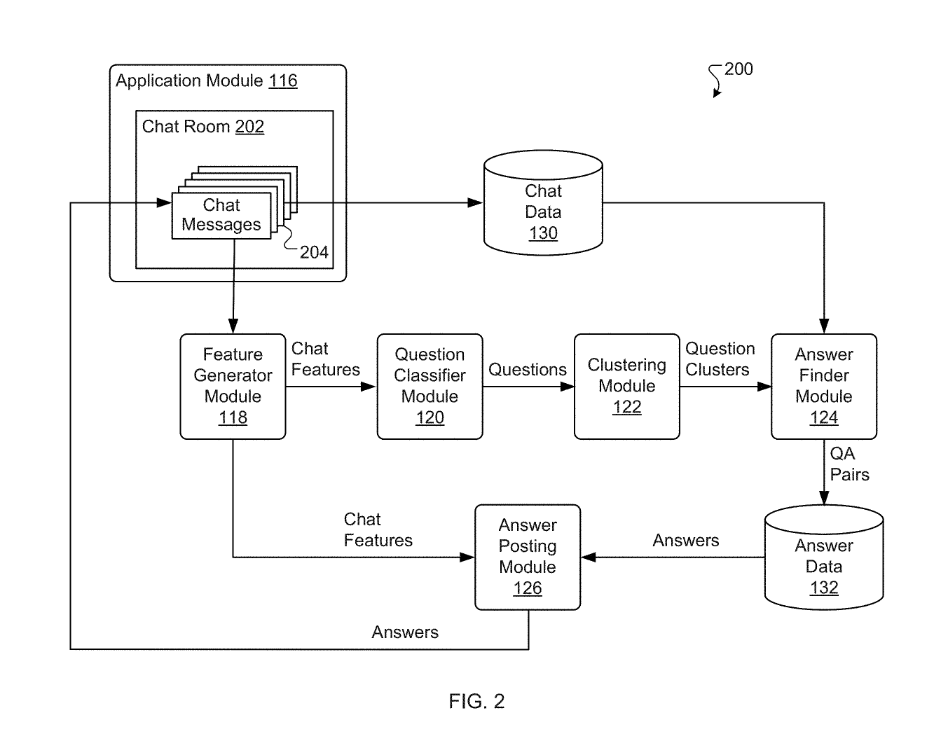

FIG. 2 is a schematic data flow diagram of a method 200 in which the application module 116, the feature generator module 118, the question classifier module 120, the clustering module 122, the answer finder module 124, and the answer posting module 126 are used to automatically respond to questions received from users of a chat room 202. The application module 120 can provide the chat room 202 and obtain chat messages 204 (e.g., text messages and/or emoji) from the users. A record of the chat messages 204 can be stored in the chat data 130 database. The chat messages 204 can be stored in any order (e.g., chronological) and/or with or without tagged mentions or threading. Each chat message 204 in the chat data 130 database can be accompanied by metadata, such as, for example, a date, a timestamp, a language, sender information, and recipient information. In a typical example, the chat messages 204 in the chat room 202 are unthreaded.

The chat messages 204 can be provided to the feature generator module 118, which can process each message to generate one or more chat features (e.g., a bag of features) for each message. The features for a message can be or include, for example, a bag of words, phrases, emoji, and/or punctuation present in the message. In some examples, the features can be represented or stored in vector form with each vector element being associated with a word, phrase, emoji, punctuation, or other message feature. The value of an element in the vector for a message can indicate the number times the feature appears in the message. For example, if a first element of the vector represents the word “game” and that word appears in the message two times, the value of the first element of the vector can be 2. Likewise, if the message includes a question mark, the value of a vector element representing question marks can be 1 for the message.

Next, the chat features from the feature generator module 118 can be provided to the question classifier module 120, which is configured to identify any questions among the chat messages 204. In preferred instances, the question classifier module 120 includes a question classifier trained to receive as input the features for a chat message 204 and provide as output an indication of whether or not (or to what degree of confidence) the chat message 204 is a question. The question classifier module 120 is preferably also configured to determine if the questions relate to a topic of interest. In the context of a chat room for an online game, for example, the question classifier module 120 can determine if a question relates to the online game. In preferred implementations, the question classifier module 120 can be configured to classify each chat message 204 into one of two classes: either a question related to the topic of interest (e.g., game play) or not (e.g., not a question or not related to the topic of interest).

In various examples, the question classifier module 120 can be configured to run real-time or batch processing algorithms on the chat messages 204, for example, to identify chat messages that are questions and related to the online game (or other topic). This can filter out relevant messages from a large number of other irrelevant chat messages 204. The question classifier module 120 can utilize support-vector machines (SVM), deep learning, or other models to distinguish relevant questions/topics from general chatter. For example, the question classifier module 120 can process the chat features from the feature generator module 118 to determine the subject matter or relevance of a message. In the context of an online game, for example, the question classifier module 120 can identify subject matter categories that the chat message belongs to, such as a specific game feature or event. Additionally or alternatively, the question classifier module 120 can add tags to the relevant questions or other chat messages 204. The tags can indicate whether a chat message is a question and/or can indicate a subject matter or topic of the message. The tags can include other meta information, such as a message timestamp, a user ID, etc.

In some implementations, the question classifier in the question classifier module 120 can be trained to distinguish relevant messages (e.g., game-related questions) from irrelevant messages (e.g., not game-related questions). The training can utilize one or more algorithms that assign weights to message features, to establish the relative importance of the features for classification. A labeled training corpus can be supplied for training the question classifier. The labels can include a class label for each question in the corpus. The various algorithms can then be used to train on this data to build the question classifier.

Still referring to FIG. 2, the identified questions (e.g., that relate to the topic of interest) and/or the features (e.g., from the feature generator module 118) associated with the identified questions can then be provided to the clustering module 122, which can cluster the questions into groups of similar or identical questions. For example, when the clustering module 122 receives two questions that are similar but worded differently, the two questions can be added to the same group. Question similarity can be determined, for example, by computing a cosine similarity between question vectors (e.g., vectors or bags of words representing the words or other features in each question). The clustering approach can facilitate the generation of automatic responses to questions, given that users often ask the same question using different wording. In some examples, the clustering module 122 can segment a set of topically linked questions into logical subtopics. The clustering can involve inducing subclusters based on semantic distances between messages and generating meaningful topic labels using keyword extraction algorithms.

In certain implementations, the clustering module 122 can include or utilize one or more clustering algorithms that work recursively by segmenting a given set of inputs into smaller sets, for example, by reducing a maximum distance between any two elements within a subset. For a given run of the clustering module 122, the eventual size and number of clusters obtained can depend on runtime parameters such as, for example, maximum size of a cluster, maximum allowable distance between a cluster, and the like. To ease human comprehension of the generated clusters (or subclusters), cluster labels can be generated using techniques that rely on frequently occurring phrases within a given cluster. The phrase generation can be done using a variety of techniques such as, for example, word n-grams, chunking, and/or graph-based algorithms (e.g., TextRank), depending on the size and complexity of the cluster. Table 1 presents an example cluster, corresponding sub-clusters, and representative questions for each sub-cluster.

TABLE 1
Example cluster, sub-clusters, and questions.

| Cluster | Sub-Cluster | Question |
|---|---|---|
| Dragon | Kill Ice | How to kill ice dragon? |
| | Dragon | Can you kill ice dragon? |
| | | How can I kill ice dragon? |
| | Train Dragon | How can I train dragon? |
| | | How do we train dragon? |
| | | You know how to train dragon? |
| | Ice Dragon | How do you get ice dragon research? |
| | Research | Where do you find the ice dragon research? |
| | | What do I need to research to hit an ice |
| | | dragon? |
| | Turkey Dragon | Anyone know max level for turkey dragon? |
| | | So what do I need to defend against the turkey |
| | | dragon? |
| | | How do I send my turkey dragon? |

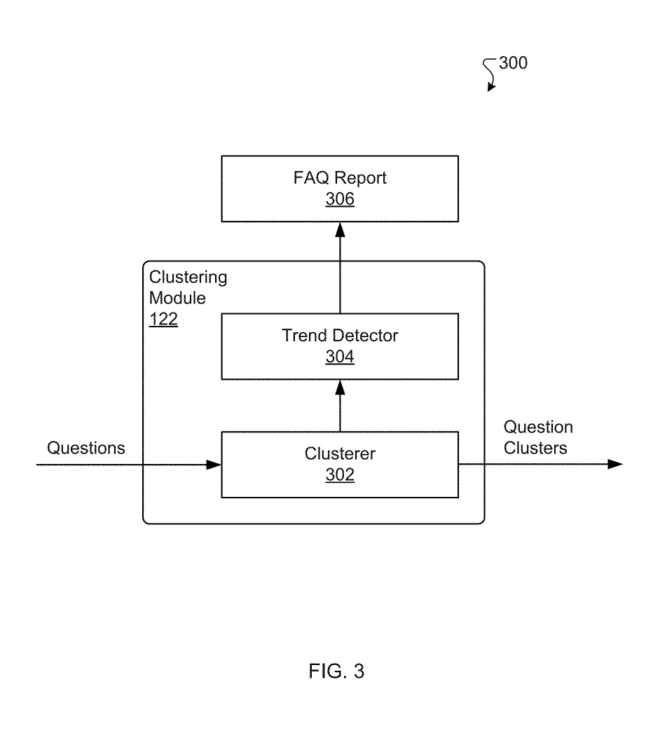

In some instances, the clustering approach can be used to identify frequently asked questions (FAQs) and/or to detect any trends in the questions. For example, referring to FIG. 3, the clustering module 122 can use a clusterer component 302 to receive questions and generate groups of similar questions, as described herein. The clustering module 122 can also include a trend detector component 304 configured to identify any trends in the questions or other chat messages. The trend detector component 304 can look for changes in question clusters over a moving window of time slices (e.g., a day or week) to identify, for example, trending FAQs for that time period. The trend detector component 304 can generate an FAQ report 306 that describes information related to FAQs and/or FAQ trends.

Referring again to FIG. 2, the identified questions and/or question clusters can then be provided to the answer finder module 124, which can obtain answers to the questions. In preferred examples, the answer finder module 124 can search the chat data 130 database for answers to the questions and/or question clusters. This can involve, for example, reviewing the record of chat messages 204 for a response to a question that appeared in the chat room 202 at around the same time (e.g., within a few seconds or minutes) that the question was posted. In some examples, for each question or question cluster, the answer finder module 124 can pull in corresponding contexts from the chat data 130 database and rank chats within this candidate pool to determine if an answer exists. If a suitable answer is found with reasonable confidence, a question and answer (QA) pair can be emitted by the answer finder module 124. Additionally or alternatively, the answer finder module 124 can search for answers by processing a set of features (e.g., from the feature generator module 118) for each possible answer. For example, a chat message 204 having features that are similar to features for a question (e.g., based on a cosine distance) may be an answer to the question. When the answer finder module 124 locates an answer to a question (or question cluster), the question and answer pair can be stored in the answer data 132 database. The question and answer pair can be validated and/or edited manually (e.g., by a subject matter expert or game provider) for correctness, grammatical accuracy, and/or validity before being entered into the answer data 132 database. Alternatively or additionally, question and answer pairs can be validated by users of the chat room 202. In some instances, for example, users can be asked to review question and answer pairs for accuracy and/or to vote on whether the question and answer pairs should be approved or disapproved. The users can be incentivized to participate in these reviews by offering rewards (e.g., virtual items or virtual currency for the online game). In a typical implementation, question and answer pairs can be added to the answer data 132 database offline, for example, by processing batches of chat data at various time intervals (e.g., daily or weekly).

In various instances, the answer finder module 124 is configured to identify, generate, and/or modify answers to questions extracted from the question classifier module 120 and/or the clustering module 122. The answer finder module 124 can include or utilize a similarity model that detects semantically similar answers for creating a pool of candidate answers. This can involve simple string matching to tree kernel implementation and deep learning that can identify semantically similar answers or questions. In some examples, the answer finder module 124 can employ majority voting and/or a relevance model to choose the correct answer (e.g., from a pool of candidates). This can involve, for example, using inverse document frequency based metrics for similarity identification to tree kernel implementation combined with deep learning techniques to identify answers to questions. Additionally or alternatively, the answer finder module 124 can be used to modify identified answers, for example, to make the answers more formal and/or comprehensive. The answer finder module 124 can utilize a classifier trained to select a best question and answer pair among available candidates.

In some implementations, the answer finder module 124 can work in three stages as follows. All operations can be performed on a given question q and a candidate answer pool A_{q}, which can contain unordered candidate answers. The first stage can involve question (query) expansion using majority voting. For each unique word within the answer pool A_{q}, the relative importance of the word can be determined by combining (i) a number of times the word occurs within A_{q} with (ii) a rareness (e.g., inverse document frequency) of the word within an entire chat corpus (e.g., all indexed chat messages). In general, when a rare word occurs frequently within the answer pool A_{q}, the word is more likely to be important for the question q. The second stage can involve information retrieval (IR) relevance model ranking. Using a suitable IR relevance model, such as BM25, the answer pool A_{q} can be re-ranked based on relevance to the question q. In some instances, for example, the answer pool A_{q} can be re-ranked based on relevance to keywords (e.g., elite keywords) in the question q, as described herein. The third stage can involve pairwise classification, in which a classifier can be used to determine the relevance of top ranked answers to the question q. This classifier is preferably trained to rule on a given pair of inputs, such as a tuple of question and answer expressed as a concatenated feature vector.

Over time, the answer data 132 database can accumulate a collection of question and answer pairs that can be used to respond to subsequent questions received from users of the chat room 202. For example, the answer posting module 126 can determine if any subsequent questions are similar to questions stored in the answer data 132 database. The answer posting module 126 can receive output from the feature generator module 118 (e.g., chat features) and/or from the question classifier module 120 (e.g., relevant questions) for subsequent questions and query the answer data 132 database for matches (e.g., based on a cosine similarity). When a high confidence match is found, the answer posting module 126 can retrieve the corresponding answer (e.g., in a canned or predetermined form) from the answer data 132 database and post the answer to the chat room 202. The answer posting module 126 can be or can utilize a conversational agent or chatbot that processes user queries and presents answers in the chat room 202. The chatbot can provide answers to user questions and/or can suggest relevant queries in an alternative case. For example, when the answer finder module 124 is unable to find an answer to a user's question, the answer finder module 124 can ask the user for clarification or can encourage the user to rephrase the question. In preferred examples, the chatbot is able to respond to user questions live or in real-time (e.g., within a few seconds of receiving a user question).

In various implementations, the challenges addressed by the systems and methods described herein can relate to question classification, question-chat similarity (e.g., question-answer similarity), and/or question-question similarity. Regarding question classification, a question classifier (e.g., in the question classifier module 120) can be developed and used to process a collection of chat messages and identify the messages that include (i) questions and (ii) belong to the domain of interest (e.g., an online game). The question classifier can help filter through vast amounts of chat data to reveal only relevant messages (e.g., questions related to the online game). For question-chat similarity, a similarity model (alternatively referred to as a question similarity model) can be developed and used to detect semantically similar questions and/or answers. The similarity model can be utilized for automatically serving responses to user questions and/or for pooling candidate answers to determine a correct answer, for example, given a question and a collection of related chat messages. The similarity model can be used to rank a set of possible answers in order of relevance to the question. Finally, regarding question-question similarity, an answer finder (e.g., the answer finder module 124) can employ majority voting in conjunction with a relevance model to choose a correct answer. When an answer to a user's question has been identified (e.g., in a database), the conversational agent or chatbot (e.g., in the answer posting module 126) can be used to automatically post the answer to the chat room.

In various implementations, the chat features provided to the question classifier module 120 can be or include linguistic cues, such as the presence of question marks, question (5W1H) words (e.g., who, when, what, why, where, and how), and POS tags, either as n-grams directly or as sequential patterns. Text can be divided into clauses and each clause can be provided as input to a trained classifier (e.g., the question classifier) to detect questions. Additionally or alternatively, syntactic pattern matching can be performed using parse trees, in which a given chat message can be expressed as a grammatical parse tree (e.g., as dictated by standard English grammar). Similarity between any two messages (e.g., questions) can be determined by comparing similarities between the parse trees for the messages. For example, the two messages “How do you train dragons?” and “How does one combine gems?” may be syntactically similar but have semantically different meanings. The syntactic similarity between messages can be revealed through parse tree comparisons. For example, both of these messages have the following sequence of parts of speech: adverb (how, how), verb (do, does), pronoun (you, one), verb (train, combine), and noun (dragons, gems).

In the context of an online game, a goal of the question classifier module 120 is to analyze all incoming chat messages (e.g., based on the chat features from the feature generator module 118) and classify each message as being a game play related question or not. Example messages for an online game are shown in Table 2. As the notes column in the table indicates, question classification in a chat environment can be challenging.

TABLE 2
Example chat messages for an online game.

| No. | Message | Notes |
|---|---|---|
| 1 | How to get gold? | A simple gameplay |
| | | related question |
| 2 | I dont know how to get gold. I have | A question, but not |
| | been low on food, I need to get more | worded as one |
| | food for upkeep, dont know what to do. | |
| 3 | How did you like the last game of | A question, but not |
| | thrones episode? | related to game play |
| 4 | How to run fake rally? | Question, but related |
| | | to a popular game hack |
| | | instead |
| 5 | Could someone tell me how to get odin | Multiple or compound |
| | and train it. | questions |
| | Will double dragons be easy to train? | |

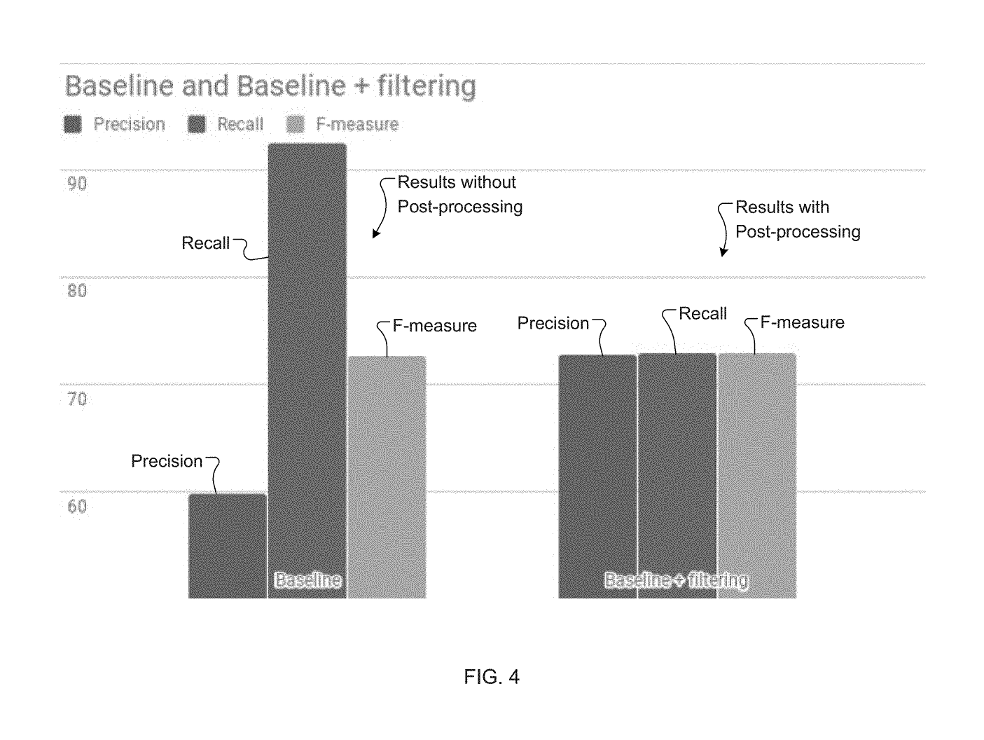

In some examples, the question classifier (e.g., an SVM classifier) can be trained using a combination of linguistic cues (e.g., 5W1H words) with a domain specific lexicon (e.g., messages for an online game). Post-processing can be performed (e.g., on training data and/or classifier output) to retain only statements or questions that contain a definite subject and object. In one instance, such post processing improved precision from a value of about 60 to a value of about 73, as shown in FIG. 4.

In various examples, the clustering module 122, the answer finder module 124, and/or the answer posting module 126 utilize the similarity model to determine whether a given pair of questions are semantically similar or not. Example pairs of questions are illustrated in Table 3. In general, the similarity model can be configured to determine semantic similarity between two questions (or answers or other statements) while respecting structural differences. The similarity model can utilize various approaches, including bag of words (and tags), coupled with a model (e.g., SVM). A flattened bag of words model can reduce each question to a set of features using part of speech and dependency tag filters (e.g., for subjects and objects, root verbs, and noun chunks).

TABLE 3
Example question pairs for an online game.

| No. | Examples | Notes |
|---|---|---|
| 1 | How to train dragons? | Simple case of similar questions |
| | How do you train dragons? | |
| 2 | How to train dragons? | A simple case of unrelated |
| | How to get gold? | questions |
| 3 | How to train dragons? | Semantically similar questions |
| | I dont know what I should do | with a complex rephrase |
| | to train dragons | |
| 4 | How to get hemlock? | Structurally very similar but |
| | How to use hemlock? | semantically unrelated |
| 5 | How to use runes? | Structurally and semantically |
| | How to set up runes? | similar |

For example, the message “How do you train dragons?” can be expressed as a bag of features having the form {word or phrase}_{feature name}. Referring to Table 4, the features for this message can include: (i) part of speech tags, (ii) subject, object, root, (iii) chunks (e.g., noun phrases or verb phrases), and (iv) named entities. An order of occurrence of the words or features in the bag can be ignored. In that sense, the sentences “How train dragon” and “Dragon train how” can have identical bags of words or features. Additionally or alternatively, a depth of the given word or phrase in a sentence parse tree can be ignored. For example, in a parse tree for “How do you train dragons?,” “train” (the root) can reside at level 0 whereas “dragon” can reside at level 2. In the generated feature list, however, both words (train and dragon) can be accorded the same level and thus, in essence, the tree is flattened.

TABLE 4
Bag of features for example message.

| Category | Features |
|---|---|
| Part of speech tags | How_ADV, do_VERB, you_PRON, |
| | train_VERB, dragons_NOUN |
| Subject, object, root | train_ROOT, you_SUBJ, dragons_OBJ |
| Chunks | you_NP, dragons_NP |
| Named Entities | dragons_GAMETERM, train_GAMETERM |

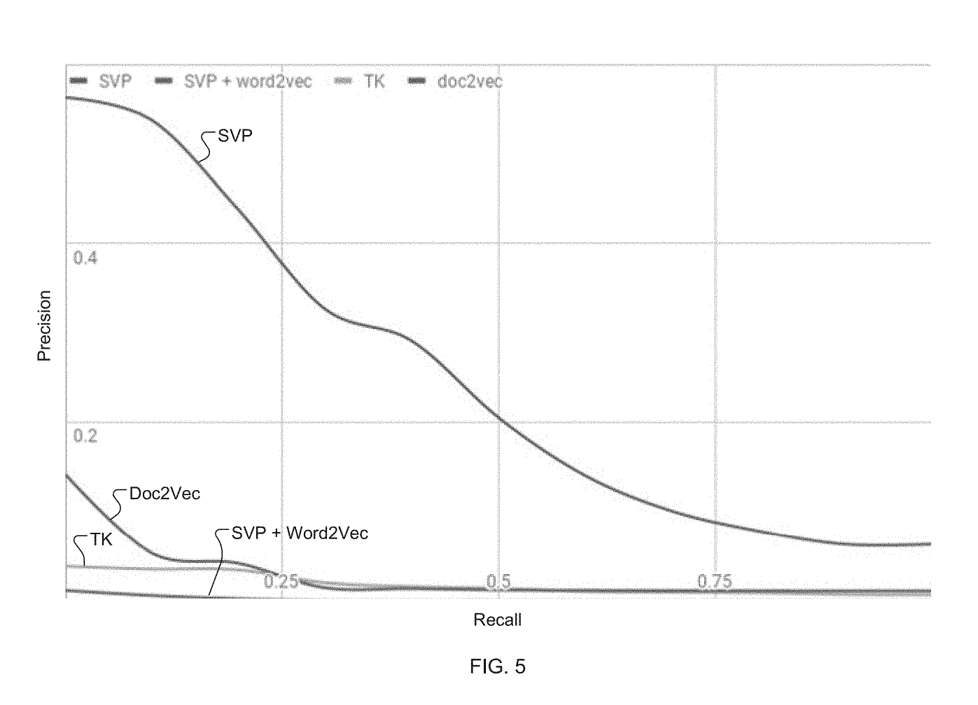

Additionally or alternatively, the similarity model can utilize an embedding based approach in which pre-trained word vectors (e.g., Word2Vec or Doc2Vec) are used to capture semantic similarity between questions and/or answers. For example, Doc2Vec can be used independently as a model. In some instances, word vectors can be used (e.g., instead of actual tags) in the bag of words (and tags) approach, which can involve, for example, SVM and Word2Vec. Additionally or alternatively, the similarity model can utilize a tree kernel approach that reduces the question/answer similarity problem to one of subtree matching. In some instances, a similarity and tree kernel approach can be used in which tree kernels are combined with similarity based measures, such as, for example, Jaccard coefficient, longest common subsequence, and/or maximum tiling. As shown in the plot of precision vs. recall in FIG. 5, in one experiment, the bag of words (SVP) approach outperformed the embedding-based (Doc2Vec and SVP+Word2Vec) and tree kernel (TK) approaches.

In various examples, the problem of question and/or answer similarity can be handled through ranking, classification, and/or paraphrase detection techniques. The ranking or classification techniques can use a variety of lexical features, such as string similarity measures (e.g., n-gram overlap, Jaccard distance, etc). Semantic features largely as pre-trained word vectors can be used where semantic distance or similarity between message pairs is used as a feature based on the problem formulation. Structural information, for example, as tree kernels and/or as recursive autoencoders can be used. Such encoders can use pre-trained word vectors; however, an open domain applicability of such vectors may not port well to specific domains (e.g., online games). These features and techniques can be used for generating pools of similar questions, generating pools of similar answers, or for finding answers that relate to a question. A larger message length can provide better features, but the overall philosophy of combining lexical, semantic, and structural features can be useful.

In certain implementations, the answer finder module 124 can utilize the question classifier and the similarity model. Given large data volumes and a rapid speed of feature deployment (e.g., for the online game), it can be impractical to generate time independent training data. One way to offset this difficulty is to cluster or pool similar questions and candidate answers (e.g., using the similarity model) and then re-rank or filter this larger set to find a best answer. More formally, given a question q and a set of candidate answers A_{q} (e.g., where |A_{q}|=n), an answer aᵢ from the candidate answers A_{q} (e.g., aᵢ∈A_{q}) is found that provides a best answer to the question q. This task can involve applying some level of thresholding on relevance, given that there may not be any right answers within A_{q}. Such challenges are illustrated by the example questions and candidate answers presented in Table 5.

TABLE 5
Example question pairs.

| No. | Question | Candidates (top 3) | Comments |
|---|---|---|---|
| 1 | How do I | Under presets then skill | Word overlap could |
| | make hero | presets | be misleading but |
| | presets? | Ex ex ex lol | may work |
| | | I don't have Hero presets | |
| | | researched so I'll have to | |
| | | wait a few months to make | |
| | | those | |
| 2 | How do I | No., Not on the new | No relevant |
| | get in | research., But still need | answers, common |
| | the new | that for other research | words in question |
| | kingdom? | and building new triops | and length bias |
| | | How do I get into the | can be troublesome |
| | | kingdom | too |
| | | New kingdoms is good | |
| 3 | How do I | go into forge then click | Multiple correct |
| | combine | on combine then select gems | answers - need to |
| | gems? | stats that u want to combine | choose the most |
| | | Go into the forge then click on | relevant or better |
| | | gems at the top then click on | worded etc. |
| | | the gems and then combine | |
| | | If you master combine you run | |
| | | the risk of not having enough | |
| | | to make a full set of 7 gems | |
| 4 | How do | You need the ultimate execution | Sometimes the right |
| | you get | skill, upgrade your graveyard | answer may have no |
| | the skull | to level 23 | word overlap and |
| | on the | build your troops to get the skull | requires semantic |
| | building? | the skull is of maxed graveyard | matching instead |

In one approach, an algorithm for the answer finder module 124 involves the following: (1) Input: Question q, candidate answers A_{q}; (2) Output: Best answer a if it exists, else None; (3) η_{q}=findEliteKeywords(A_{q}); (4) A_{q}=filter(A_{q}, q, η_{q}); and (5) return rankAndClassify(q, A_{q}). In the first step, the user question can be expanded by finding elite keywords from A_{q} as follows. Considering all unique tokens within A_{q}, a weight w(t) can be computed for each word or token as

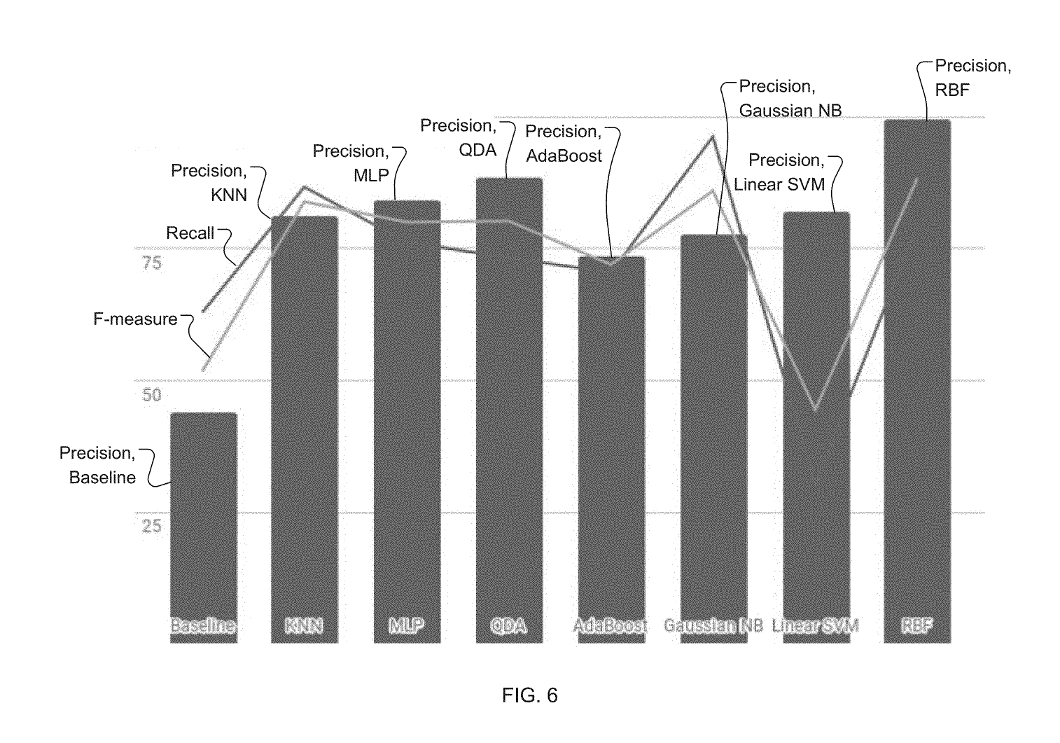

w(t)=tf_{A}(t)*IDF(t), (1)

where tf_{A}(t) refers to a normalized term frequency within the collection A_{q}, and IDF(t) is a corpus level inverse document frequency (IDF) defined as log(N/df). Next, words are picked that have a weight w(t) that is greater than or equal to a threshold value, such as 0.8 times a maximum weight within the set of words. A basic premise behind this expansion is that when rare terms occur frequently within the set, then such words may be relevant to the answer. The next step is to re-rank the candidate answers based on relevance to the question expanded with the elite keywords. This can be done using an information retrieval (IR) model, such as BM25 or the like. A classifier (e.g., SVM) can then be used to determine if the given question answer pair is relevant or not. The classifier can be trained on bag of word features. Values for precision, recall, and F-measure for a simple Naïve Bayes baseline system compared with a variety of different classifiers are provided in FIG. 6. The classifiers represented in this figure are: K-Nearest Neighbor (KNN), Multilayer Perceptron (MLP), Quadratic (QDA), AdaBoost, Gaussian Naive Bayes (Gaussian NB), Linear SVM, and Radial Basis Function (RBF). To measure the quality of the machine generated answers, human generated answers were obtained for a set of test questions and a word overlap was calculated using ROUGE. The ROUGE results are presented in Table 6.

TABLE 6
ROUGE scores between automatic answers
and human expert answers.

| Metric | Recall | Precision | F-score |
|---|---|---|---|
| ROUGE-1 | 32.6 | 69.68 | 44.42 |
| ROUGE-2 | 10.25 | 22.37 | 14.06 |
| ROUGE-3 | 3.32 | 7.40 | 4.58 |

As described herein, the similarity model can utilize a word embedding-based approach (e.g., Word2Vec). In the context of a chat room for an online game, however, the embedding approach may not perform as well as other similarity model approaches, such as bag of words. An investigation into this performance limitation has revealed that pre-trained word vectors can fail to capture semantic similarity between game terms. One reason for this behavior may be attributed to the fact that many game terms have mythological origins and hence may not be commonly found in news or Wikipedia articles on which word vectors are typically trained. To further evaluate the efficacy of such vectors, two additional datasets were created.

One dataset was an abbreviations dataset containing game terms and common abbreviations for the game terms, as used by players (e.g., RSS=resources, SH=stronghold, etc.). The abbreviations (Abbr) dataset was used to evaluate a closest match. For example, for a given abbreviation, determine if a closest neighbor contains a corresponding expansion. The closest match for an abbreviation can be defined as the abbreviation's corresponding expansion (e.g., “RSS” expands to “resources” and “SH” expands to “stronghold”). In general, an abbreviation and corresponding expansion can be semantically equivalent, given that the abbreviation and the expansion can be used interchangeably, with no difference in meaning. The abbreviations dataset can be used to determine if the similarity model has successfully learned these correspondences. For example, when the similarity model has learned the relationship between an abbreviation and a corresponding expansion, the similarity model should recognize that the abbreviation and the expansion are closest neighbors. The similarity model can determine similarity using a distance metric.

The other dataset was a multiword (MW) expressions dataset containing multiword game term pairs that are semantically analogous, such as special event name pairs (e.g., “Fall Frenzy,” “Weather Warrior,” etc.). Such expressions can be utilized as analogy questions, e.g., Fall::Frenzy then Weather::? Semantic models can be utilized to answer analogies. For example, a model that understands relations between countries and cities can be used to answer the analogy: if France::Paris, then Egypt::Cairo. Similarly, when the model has been trained to learn semantic equivalences between game terms, the model can be used to answer analogies based on game terms, such as, for example, between the special event name pairs “Fall Frenzy” and “Weather Warrior.”

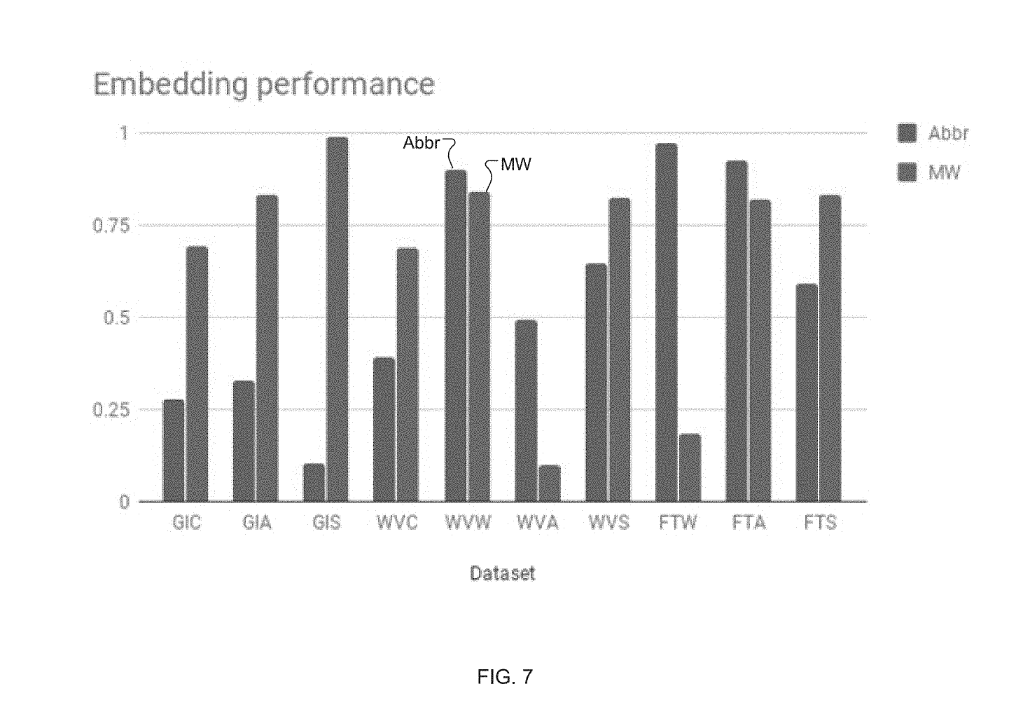

The following models were evaluated: GloVe trained on Common Crawl (GlC); GloVe trained on game chat all (GlA); GloVe trained on game chat sampled (GlS); Word2Vec trained on Common Crawl (WVC); Word2Vec trained on Wikipedia (WVW); Word2Vec trained on game chat all (WVA); Word2Vec trained on game chat sampled (WVS); FastText trained on Wikipedia (FTW); FastText trained on game chat all (FTA); and FastText trained on game chat sampled (FTS). The “game chat all” dataset included all chat data collected for a month in an online game, with no sampling and limited to 250 k messages. The “game chat sampled” dataset included about 200 k chat data messages for the online game restricted to detected questions and corresponding context. Precision values for these models are presented in FIG. 7. As can be seen, the FTA model outperformed other models across the board and also did better on the abbreviations dataset when compared to the Multiword dataset.

In various examples, the chat messages 204 can be in any language and/or in multiple languages. Automatic machine translations can be performed, as needed, to translate the chat messages 204 and/or answers to different languages. Alternatively or additionally, in some examples, chat messages 204 can be transformed to eliminate chat speak, abbreviations, slang, etc., so that the chat messages 204 are more formal and/or more suitable for processing by the feature generator module 118 and other system components. Chat message transformation techniques are described in U.S. Pat. No. 9,600,473, issued Mar. 21, 2017, and titled “Systems and Methods for Multi-User Multi-Lingual Communications,” the entire disclosure of which is incorporated by reference herein.

In certain implementations, answers provided by some users can be given more weight than answers provided by other users. The weight can depend on the user and can represent a level of confidence in the user's ability to provide accurate answers. In the case of an online game, for example, answers from more experienced or more capable users can be given a higher weight. The answer finder module 124 can be configured to prefer answers having a higher weight.

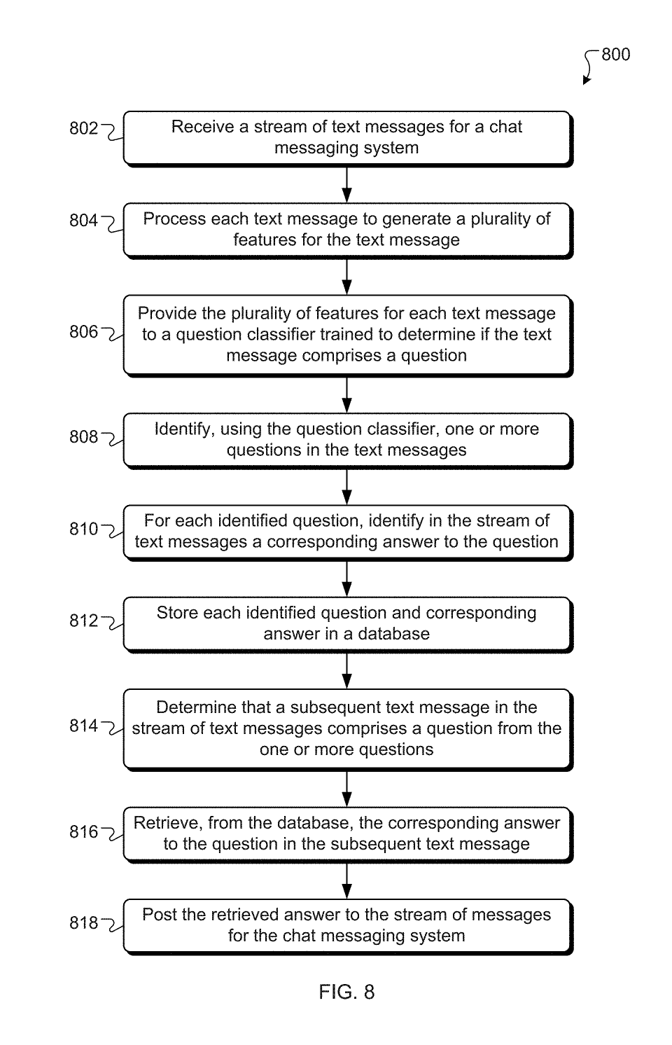

FIG. 8 illustrates an example computer-implemented method 800 of providing answers to user questions in an online chat messaging system. A stream or sequence of text messages is received (step 802) for a chat messaging system. The stream of text messages includes messages from a plurality of users of the chat messaging system. Each text message is processed (step 804) to generate a plurality of features for the text message. The plurality of features for each text message is provided (step 806) to a question classifier trained to determine, based on the plurality of features, if the text message is or includes a question. The question classifier is used to identify (step 808) one or more questions in the text messages. For each identified question, a corresponding answer to the question is identified (step 810) in the stream of text messages. Each identified question and corresponding answer is stored (step 812) in a database. A determination is made (step 814) that a subsequent text message in the stream of text messages includes a question from the one or more questions. The corresponding answer to the question in the subsequent text message is retrieved (step 816) from the database. The retrieved answer is posted (step 818) to the stream of messages for the chat messaging system.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
receiving a stream of text messages for a chat messaging system, the stream of text messages comprising messages from a plurality of users of the chat messaging system;
processing each text message to generate a plurality of features for the text message;
providing the plurality of features for each text message to a question classifier trained to determine, based on the plurality of features, if the text message comprises a question;
identifying, using the question classifier, one or more questions in the text messages;
for each identified question, identifying in the stream of text messages a corresponding answer to the question;
storing, in a database, each identified question and corresponding answer;
determining that a subsequent text message in the stream of text messages comprises a question from the one or more questions;
retrieving, from the database, the corresponding answer to the question in the subsequent text message; and
posting the retrieved answer to the stream of messages for the chat messaging system.

2. The method of claim 1, wherein the plurality of features for each text message comprises a bag of words.

3. The method of claim 1, wherein identifying the one or more questions comprises:
determining that each question in the one or more questions relates to a software application used by the plurality of users.

4. The method of claim 1, wherein identifying the one or more questions in the text messages comprises:
clustering the one or more questions into one or more groups, each group comprising identical questions or similar questions.

5. The method of claim 1, wherein identifying the one or more questions in the text messages comprises:
identifying frequently asked questions among the identified one or more questions.

6. The method of claim 1, wherein identifying the corresponding answer comprises:
finding a message in the stream of text messages that is semantically similar to the question.

7. The method of claim 1, wherein identifying the corresponding answer comprises:
generating a pool of candidate answers that are semantically similar to the question; and
selecting a best answer from the pool of candidate answers.

8. The method of claim 1, wherein storing each identified question and corresponding answer comprises:
storing the identified question and corresponding answer in the database as a question and answer pair.

9. The method of claim 1, wherein determining that the subsequent text message comprises the question comprises:
processing the subsequent text message to generate a plurality of features for the subsequent text message;
using the question classifier to determine, based on the plurality of features for the subsequent text message, that the subsequent text message comprises a question; and
determining, based on the plurality of features, that the question in the subsequent text message is similar or identical to the question from the one or more questions.

10. The method of claim 1, further comprising:
obtaining a set of training messages for the question classifier, a portion of the training messages comprising questions;
processing each training message to generate a plurality of features for the training message; and
training the question classifier to recognize the questions in the training messages based on the plurality of features for the training messages.

11. A system, comprising:
one or more computer processors programmed to perform operations comprising:
receiving a stream of text messages for a chat messaging system, the stream of text messages comprising messages from a plurality of users of the chat messaging system;
processing each text message to generate a plurality of features for the text message;
providing the plurality of features for each text message to a question classifier trained to determine, based on the plurality of features, if the text message comprises a question;
identifying, using the question classifier, one or more questions in the text messages;
for each identified question, identifying in the stream of text messages a corresponding answer to the question;
storing, in a database, each identified question and corresponding answer;
determining that a subsequent text message in the stream of text messages comprises a question from the one or more questions;
retrieving, from the database, the corresponding answer to the question in the subsequent text message; and
posting the retrieved answer to the stream of messages for the chat messaging system.

12. The system of claim 11, wherein identifying the one or more questions comprises:
determining that each question in the one or more questions relates to a software application used by the plurality of users.

13. The system of claim 11, wherein identifying the one or more questions in the text messages comprises:
clustering the one or more questions into one or more groups, each group comprising identical questions or similar questions.

14. The system of claim 11, wherein identifying the one or more questions in the text messages comprises:
identifying frequently asked questions among the identified one or more questions.

15. The system of claim 11, wherein identifying the corresponding answer comprises:
finding a message in the stream of text messages that is semantically similar to the question.

16. The system of claim 11, wherein identifying the corresponding answer comprises:
generating a pool of candidate answers that are semantically similar to the question; and
selecting a best answer from the pool of candidate answers.

17. The system of claim 11, wherein storing each identified question and corresponding answer comprises:
storing the identified question and corresponding answer in the database as a question and answer pair.

18. The system of claim 11, wherein determining that the subsequent text message comprises the question comprises:
processing the subsequent text message to generate a plurality of features for the subsequent text message;
using the question classifier to determine, based on the plurality of features for the subsequent text message, that the subsequent text message comprises a question; and
determining, based on the plurality of features, that the question in the subsequent text message is similar or identical to the question from the one or more questions.

19. The system of claim 11, further comprising:
obtaining a set of training messages for the question classifier, a portion of the training messages comprising questions;
processing each training message to generate a plurality of features for the training message; and
training the question classifier to recognize the questions in the training messages based on the plurality of features for the training messages.

20. An article, comprising:
a non-transitory computer-readable medium having instructions stored thereon that, when executed by one or more computer processors, cause the one or more computer processors to perform operations comprising:
receiving a stream of text messages for a chat messaging system, the stream of text messages comprising messages from a plurality of users of the chat messaging system;
processing each text message to generate a plurality of features for the text message;
providing the plurality of features for each text message to a question classifier trained to determine, based on the plurality of features, if the text message comprises a question;
identifying, using the question classifier, one or more questions in the text messages;
for each identified question, identifying in the stream of text messages a corresponding answer to the question;
storing, in a database, each identified question and corresponding answer;
determining that a subsequent text message in the stream of text messages comprises a question from the one or more questions;
retrieving, from the database, the corresponding answer to the question in the subsequent text message; and
posting the retrieved answer to the stream of messages for the chat messaging system.
